(19) United States
(12) Patent Application Publication
(10) Pub. No.: US 2024/0054607 A1
(43) Pub. Date: Feb. 15, 2024

(54) REDUCING THE COMPLEXITY OF VIDEO QUALITY METRIC CALCULATIONS

(71) Applicant: Meta Platforms, Inc., Menlo Park, CA (US)

(72) Inventors: Ioannis Katsavounidis, San Jose, CA (US); Cosmin Vasile Stejerean, Las Vegas, NV (US)

(21) Appl. No.: 17/479,799

(22) Filed: Sep. 20, 2021

(51) Int. Cl. G06T 5/20; G06T 5/00; G06T 5/10

(52) U.S. Cl. CPC G06T 5/20; G06T 5/009; G06T 5/10; G06T 2207/20064

(57) ABSTRACT

A first component image quality metric included in a plurality of eligible component image quality metrics is computed. A reference version of a video frame is decomposed into a first set of decomposed levels in different scales. A distorted version is decomposed into a second set of decomposed levels in different scales. Detail loss is determined based on the first set and second set of decomposed levels in different scales. A second component image quality metric included in the eligible component image quality metrics is computed. The first set and second set of decomposed levels in different scales are reused for computing the second component image quality metric. Natural scene statistics are evaluated based on the first set and second set of decomposed levels in different scales. A video quality metric for the distorted version is determined based on at least a portion of the eligible component image quality metrics.

### BACKGROUND OF THE INVENTION

A video coding format is a content representation format for storage or transmission of digital video content (such as in a data file or bitstream). It typically uses a standardized video compression algorithm. Examples of video coding formats include H.262 (MPEG-2 Part 2), MPEG-4 Part 2, H.264 (MPEG-4 Part 10), HEVC (H.265), Theora, RealVideo RV40, VP9, and AV1. A video codec is a device or software that provides encoding and decoding for digital video. Most codecs are typically implementations of video coding formats.

Recently, there has been an explosive growth of video usage on the Internet. Some websites (e.g., social media websites or video sharing websites) may have billions of users and each user may upload or download one or more videos each day. When a user uploads a video from a user device onto a website, the website may store the video in one or more different video coding formats, each being compatible with or more efficient for a certain set of applications, hardware, or platforms. However, with many uploaded videos from different users and user devices, the quality of the videos varies. Video quality metrics play an essential role in determining the coding parameters for subsequent processing of the uploaded videos. Therefore, improved techniques for calculating video quality metrics would be desirable.

### BRIEF DESCRIPTION OF THE DRAWINGS

Various embodiments of the invention are disclosed in the following detailed description and the accompanying drawings.

FIG. 1 illustrates a block diagram of an embodiment of a video encoder 100.

FIG. 2 illustrates an example of a model 200 used by VIF for measuring information loss between a perceived version 210 of an original image 202 and a perceived version 212 of a distorted image 209.

FIG. 3 illustrates a multi-scale pixel domain VIF decomposition 300 applied to a plurality of video frames 302.

FIG. 4 illustrates an exemplary process 400 for calculating the VIF natural scene statistics at each level.

FIG. 5 illustrates an exemplary process 500 for the computation of the Detail Loss Metric (DLM) and Additive Impairment Measure (AIM).

FIG. 6 illustrates an example of a multi-scale wavelet decomposition 600 with four levels.

FIG. 7 illustrates an exemplary process for determining a video quality metric.

FIG. 8 illustrates an exemplary process 800 for computing a component image quality metric that determines detail loss in images.

FIG. 9 illustrates an exemplary process 900 for computing a component image quality metric that evaluates image quality based on natural scene statistics.

FIG. 10 illustrates an exemplary process 1000 for calculating the VIF statistics at each level.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

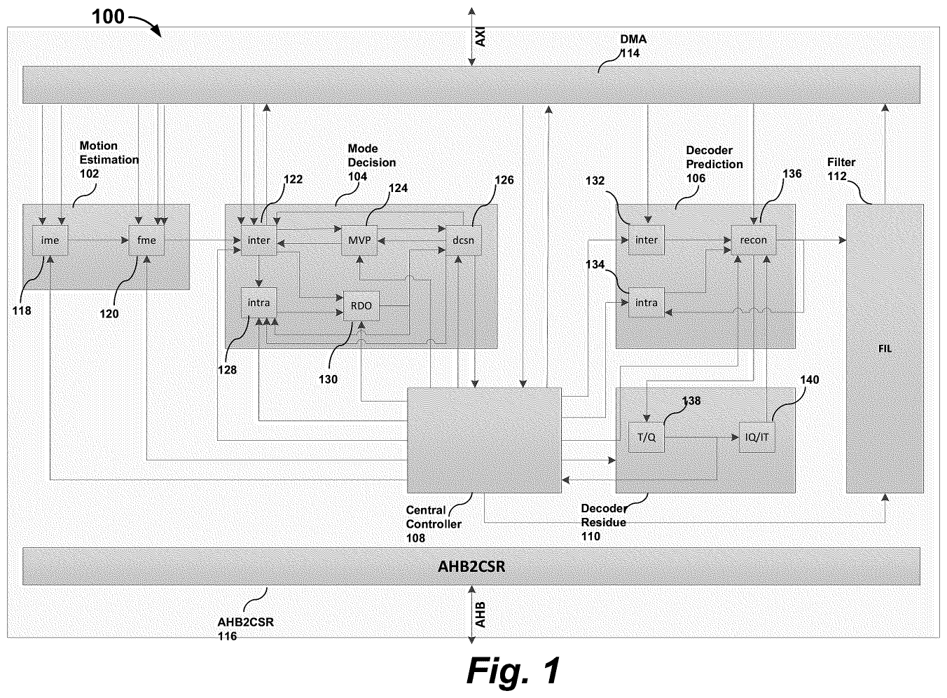

FIG. 1 illustrates a block diagram of an embodiment of a video encoder 100. For example, video encoder 100 supports the video coding format H.264 (MPEG-4 Part 10). However, video encoder 100 may also support other video coding formats as well, such as H.262 (MPEG-2 Part 2), MPEG-4 Part 2, HEVC (H.265), Theora, RealVideo RV40, AV1 (Alliance for Open Media Video 1), and VP9.

Video encoder 100 includes many modules. Some of the main modules of video encoder 100 are shown in FIG. 1. As shown in FIG. 1, video encoder 100 includes a direct memory access (DMA) controller 114 for transferring video data. Video encoder 100 also includes an AMBA (Advanced Microcontroller Bus Architecture) to CSR (control and status register) module 116. Other main modules include a motion estimation module 102, a mode decision module 104, a decoder prediction module 106, a central controller 108, a decoder residue module 110, and a filter 112.

Video encoder 100 includes a central controller module 108 that controls the different modules of video encoder 100, including motion estimation module 102, mode decision module 104, decoder prediction module 106, decoder residue module 110, filter 112, and DMA controller 114.

Video encoder 100 includes a motion estimation module 102. Motion estimation module 102 includes an integer motion estimation (IME) module 118 and a fractional motion estimation (FME) module 120. Motion estimation module 102 determines motion vectors that describe the transformation from one image to another, for example, from one frame to an adjacent frame. A motion vector is a two-dimensional vector used for inter-frame prediction; it refers the current frame to the reference frame, and its coordinate values provide the coordinate offsets from a location in the current frame to a location in the reference frame. Motion estimation module 102 estimates the best motion vector, which may be used for inter prediction in mode decision module 104. An inter coded frame is divided into blocks known as macroblocks. Instead of directly encoding the raw pixel values for each block, the encoder will try to find a block similar to the one it is encoding on a previously encoded frame, referred to as a reference frame. This process is done by a block matching algorithm. If the encoder succeeds on its search, the block could be encoded by a vector, known as a motion vector, which points to the position of the matching block at the reference frame. The process of motion vector determination is called motion estimation.

Video encoder 100 includes a mode decision module 104. The main components of mode decision module 104 include an inter prediction module 122, an intra prediction module 128, a motion vector prediction module 124, a rate-distortion optimization (RDO) module 130, and a decision module 126. Mode decision module 104 detects one prediction mode among a number of candidate inter prediction modes and intra prediction modes that gives the best results for encoding a block of video.

Decoder prediction module 106 includes an inter prediction module 132, an intra prediction module 134, and a reconstruction module 136. Decoder residue module 110 includes a transform and quantization module (T/Q) 138 and an inverse quantization and inverse transform module (IQ/IT) 140.

Video quality metrics may be used to evaluate the quality of different video codecs, encoders, encoding settings, or transmission variants. Video Multimethod Assessment Fusion (VMAF) is an objective full-reference video quality metric. It predicts subjective video quality based on reference and distorted video sequences. VMAF uses existing image quality metrics and other features to predict video quality. It is a fusion-based video quality assessment method that includes multiple component metrics. The VMAF standard model uses features from three component metrics, including Visual Information Fidelity (VIF), Detail Loss Metric (DLM), and motion, fused with a support vector regression (SVR) model.

Visual Information Fidelity (VIF) is a full reference image quality assessment index based on natural scene statistics and the notion of image information extracted by the human visual system. VIF considers information fidelity loss at four different spatial scales; the features corresponding to these 4 different spatial scales are actually being used in the standard VMAF model, rather than the full VIF metric. It is deployed in the core of the Netflix VMAF video quality monitoring system, which controls the picture quality of all encoded videos streamed by Netflix. Detail Loss Metric (DLM) measures loss of details, and impairments which distract viewer attention. Motion is defined as the Mean Absolute Difference (MAD) of consecutive low-pass filtered video frames. In VMAF, the above component metrics are fused using a support-vector machines (SVM) based regression to provide a single output score in the range of 0-100 per video frame, with 100 having a quality identical to the reference video. Calculating VMAF is computationally intensive and therefore consumes a significant amount of power. Therefore, improved techniques to reduce the complexity of calculating VMAF would be desirable.

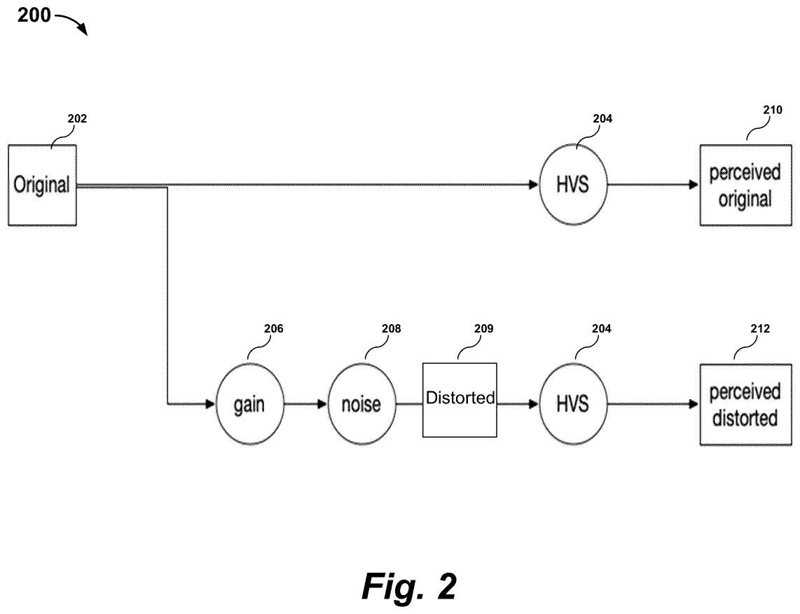

FIG. 2 illustrates an example of a model 200 used by VIF for measuring information loss between a perceived version 210 of an original image 202 and a perceived version 212 of a distorted image 209. Both the perceived original image 210 and the perceived distorted image 212 are as perceived by the same human visual system (HVS) 204. The distorted image 209 is modeled as having two separate operations being applied to the original image 202, including a gain term 206 and an additive white noise term 208. The HVS 204 is modeled as an additive white gaussian noise term.

Based on model 200, the mutual information between the perceived original image 210 (after HVS processing) and the original image 202 may be computed. Similarly, the mutual information between the perceived distorted image 212 and the original image 202 may be computed. VIF is then defined as the ratio between these two mutual information measures.

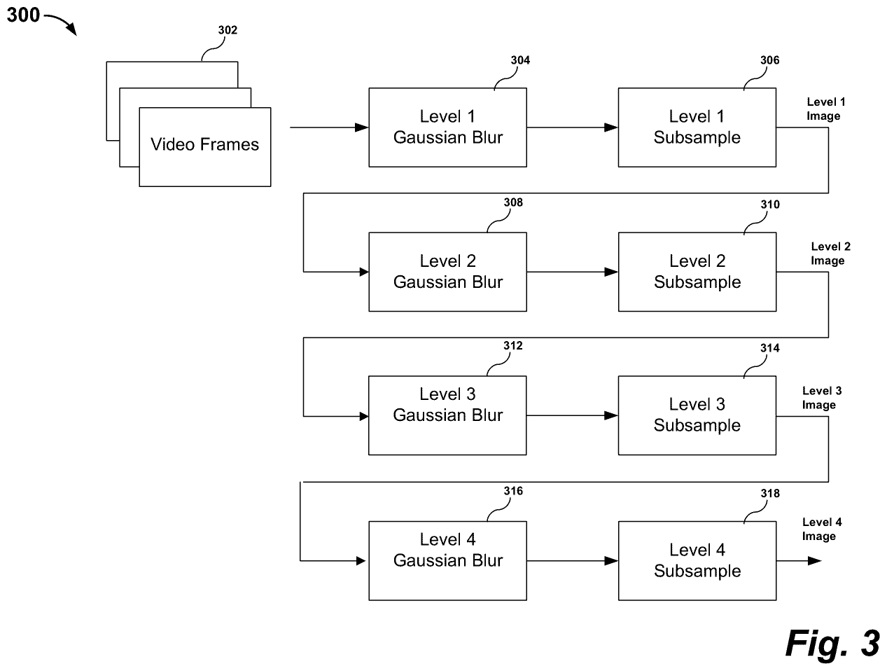

FIG. 3 illustrates a multi-scale pixel domain VIF decomposition 300 applied to a plurality of video frames 302. Video frames 302 are original video frames or the tested video frames. In other words, the decomposition is performed on the video frames being tested and the original video frames. The pixel domain version of VIF in VMAF uses a different level of Gaussian blurring and subsampling for each scale. The number of levels is M, where M is an integer. Typically, there are four levels of Gaussian blurring and subsampling. For example, as shown in FIG. 3, a video frame 302 is processed by a Level-1 (L1) Gaussian Blur module 304 and a Level-1 (L1) subsampling module 306. The output of Level-1 is a Level-1 scaled version of the image, which is then processed by a Level-2 (L2) Gaussian Blur module 308 and a Level-2 (L2) subsampling module 310. The output of Level-2 is a Level-2 scaled version of the image, which is then processed by a Level-3 (L3) Gaussian Blur module 312 and a Level-3 (L3) subsampling module 314, and finally the output of Level-3 is processed by a Level-4 (L4) Gaussian Blur module 316 and a Level-4 (L4) subsampling module 318.

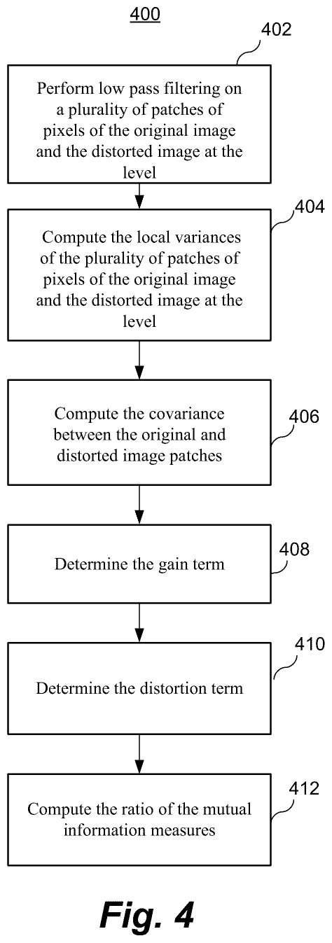

VIF uses natural scene statistics to determine the degree of distortion between the tested video frame and the original video frame. For each scale, the VIF statistics are calculated with a sliding window over the image. FIG. 4 illustrates an exemplary process 400 for calculating the VIF natural scene statistics at each level.

At 402, at each decomposed level, low pass filtering is performed on a plurality of patches of pixels corresponding to the original image. At each decomposed level, low pass filtering is performed on a plurality of patches of pixels corresponding to the distorted image. In some embodiments, the same Gaussian kernel used for Gaussian blurring may be used at step 402. At 404, the local variances of the plurality of patches of pixels of the original image (σ_{C}²) and the distorted image (σ_{D}²) at the level are computed. At 406, the covariance between the original and distorted image patches (σ_{CD}) is computed. At 408, the gain term g is estimated using

$$g = \frac{{σ}_{CD}}{{σ}_{C}^{2}} .$$

At 410, the distortion term V is determined using σ_{V}²=σ_{D}²−g·σ_{CD}.

At 412, the ratio of the mutual information measures is computed based on the sum of the local statistics combined as follows:

$$VIF = \frac{{\sum }_{i = 1}^{N} {log}_{2} ( 1 + \frac{{g}_{i}^{2} {σ}_{Ci}^{2}}{{σ}_{{v}_{i}}^{2} + {σ}_{N}^{2}} )}{{\sum }_{i = 1}^{N} {log}_{2} ( 1 + \frac{{σ}_{Ci}^{2}}{{σ}_{N}^{2}} )}$$

where σ_{N}² is the variance of the HVS system additive noise. In the VMAF implementation, σ_{N}² set at 2.

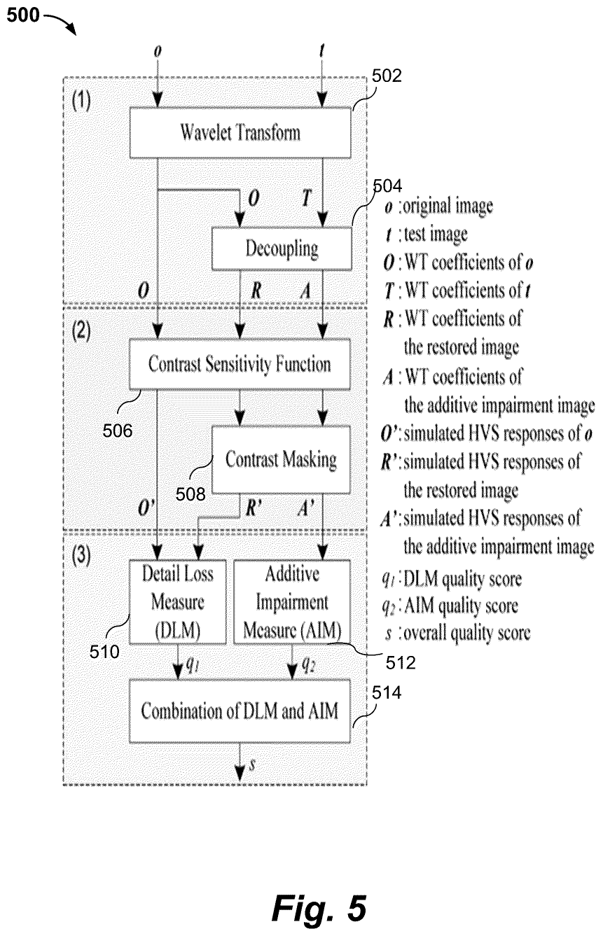

FIG. 5 illustrates an exemplary process 500 for the computation of the Detail Loss Metric (DLM) and Additive Impairment Measure (AIM). DLM measures the detail loss of the image. VMAF only uses DLM but not AIM as a component metric. Therefore, the computation of AIM by module 512 and the computation of the combination of DLM and AIM by module 514 as shown in FIG. 5 may be omitted in VMAF.

DLM in VMAF is computed in the wavelet domain. As shown in FIG. 5, the inputs to process 500 include an original image o and a test image t. At step (1), both images are first processed by a wavelet transform module 502 to generate O and T, where O is the wavelet transform coefficients of image o and T is the wavelet transform coefficients of image t.

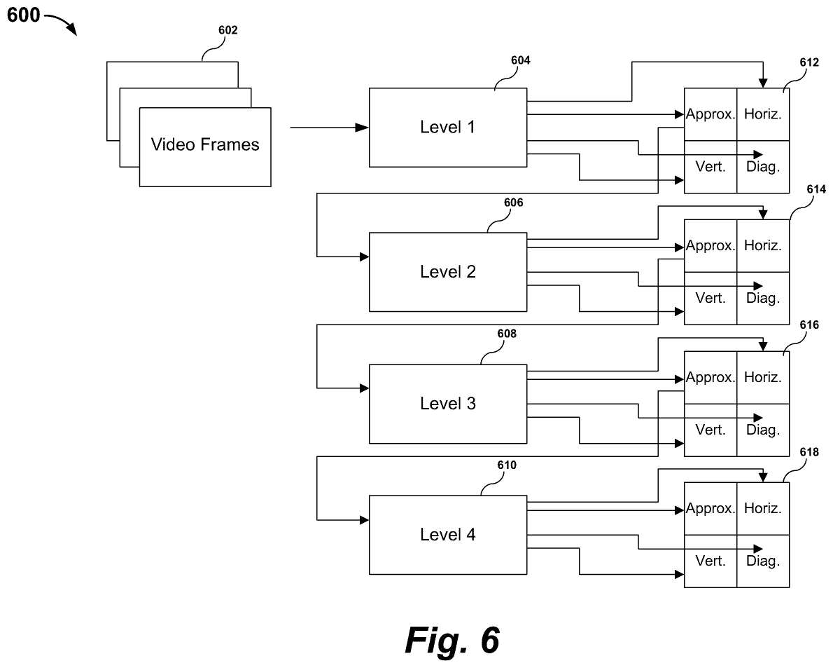

FIG. 6 illustrates an example of a multi-scale wavelet decomposition 600 with four levels. In some embodiments, decomposition 600 is performed by wavelet transform module 502. As shown in FIG. 6, a multi-level Discrete Wavelet Transform (DWT) is applied to a plurality of video frames 602. The number of levels is N, where N is an integer. The DLM component metric for VMAF applies a four-level DWT to the video frames 602.

As shown in FIG. 6, the plurality of video frames 602 are decomposed into wavelet sub-bands in four different levels and different orientations. A video frame 602 is processed by a Level-1 (L1) decomposition module 604, which comprises a filter bank with low-pass and high pass filters. Level-1 module 604 generates a Level-1 wavelet decomposition output 612. Output 612 includes four sub-bands, which are referred to as the low-low (LL), low-high (LH), high-low (HL), and high-high (HH) sub-bands. The LL sub-band is an approximation L1 sub-band, which approximates the input image/video frame. It is a low frequency sub-band used for the successive decomposition process. The LH sub-band is a horizontal L1 sub-band, which extracts the edge information in the horizontal direction of the original image. The HL sub-band is a vertical L1 sub-band, which extracts the edge information in the vertical direction of the original image. The HH sub-band is a diagonal L1 sub-band, which extracts the edge information in the diagonal direction of the original image.

The approximation L1 sub-band is then processed by a Level-2 (L2) decomposition module 606, which comprises another filter bank with low-pass and high pass filters. Level-2 module 606 generates a Level-2 wavelet decomposition output 614, which includes an approximation L2 sub-band, a vertical L2 sub-band, a horizontal L2 sub-band, and a diagonal L2 sub-band. The approximation L2 sub-band is then processed by a Level-3 decomposition module 608 that generates a Level-3 wavelet decomposition output 616, and finally the approximation L3 sub-band is processed by a Level-4 decomposition module 610 that generates a Level-4 decomposition output 618. Output 616 and output 618 each include four sub-bands, namely the approximation, vertical, horizontal, and diagonal sub-bands of the level. It should be recognized that the approximation sub-band at each level has a different scale. At each level, the scale is ¼ of that in the previous level.

The DLM component metric for VMAF applies a four-level Daubechies 2 (db2) DWT to the video frames 602. Daubechies 2 is a 4-tap wavelet. The decomposition module at each level includes a 4-tap decomposition low-pass filter and a 4-tap decomposition high-pass filter.

With reference again to FIG. 5, after the DWT decomposition, at step (1) of process 500, a decoupling of T is performed by a decoupling module 504. T is decoupled into two components, the wavelet transform coefficients, R, of the restored image and the wavelet transform coefficients, A, of the additive impairment image. R approximates the detail losses and A contains everything else, and is defined as A=T−R. The decoupling is done by comparing against O.

For the HVS function, a Contrast Sensitivity Function (CSF) and a Contrast Masking (CM) function are applied to the restored coefficients R, while only the CSF function is applied to O. The CSF function is implemented as sub-band weighting to account for the contrast sensitivity of the nominal spatial frequency for each level. The sub-band weights associated with CSF are as defined in the original DLM standard. The Contrast Masking function assumes that the restored image R and the additive impairment image A are both viewed at the same time and essentially each acts as a mask for the other. Therefore, the coefficients in A are used as the contrast mask for R.

After the restored image R has been processed by the HVS (i.e., CSF+CM), then at step (3) of process 500, DLM 510 is computed as a ratio between the Minkowski sum of the coefficients of the restored image R and those of the original image O. DLM only uses the detail sub-bands across all levels and completely ignores the approximation sub-band (which contains very little by the fourth scale).

Among the three component metrics of VMAF, VIF is the most computationally intensive. Therefore, the complexity of VMAF may be reduced by simplifying the VIF calculations, including by modifying VIF to reuse some of the computations that are performed for DLM. As shown above, both DLM and VIF decompose the images into multiple scales but use different ways of decomposing the image. To reduce the complexity of calculating VMAF, both DLM and VIF may be computed based on a single shared decomposition in the wavelet domain.

In the present application, a method of calculating Video Multimethod Assessment Fusion (VMAF) is disclosed. A reference version and a distorted version of a video frame are received. A first component image quality metric included in a plurality of eligible component image quality metrics is computed. A reference version of a video frame is decomposed into a first set of decomposed levels in different scales. A distorted version is decomposed into a second set of decomposed levels in different scales. Detail loss is determined based on the first set and second set of decomposed levels in different scales. A second component image quality metric included in the plurality of eligible component image quality metrics is computed. The first set and second set of decomposed levels in different scales are reused for computing the second component image quality metric. Natural scene statistics are evaluated based on the first set and second set of decomposed levels in different scales. A video quality metric for the distorted version is determined based on at least a portion of the eligible component image quality metrics.

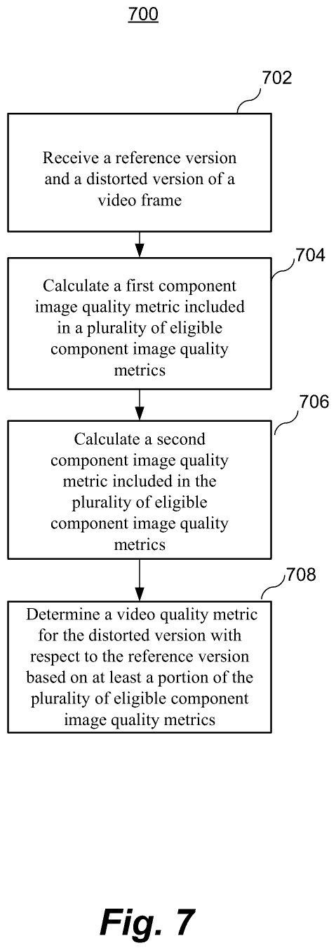

FIG. 7 illustrates an exemplary process 700 for determining a video quality metric. At step 702, a reference version and a distorted version of a video frame are received.

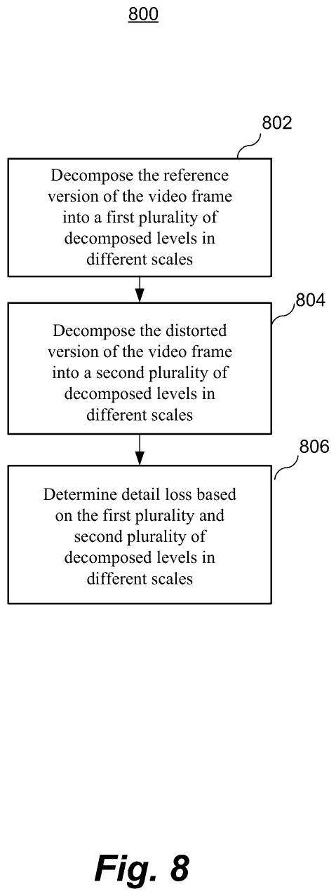

At step 704, a first component image quality metric included in a plurality of eligible component image quality metrics is computed. In some embodiments, the first component image quality metric is DLM, which is one of the three component image quality metrics for VMAF. FIG. 8 illustrates an exemplary process 800 for computing a component image quality metric that determines detail loss in images. In some embodiments, process 800 may be performed at step 704 of process 700. In some embodiments, the steps of process 800 are similar to the steps in process 500. Some of the steps in process 800 may include modifications and additional features to reduce the complexity of the computation of VMAF, as will be described in greater detail below.

With reference to FIG. 8, at step 802, the reference version of the video frame is decomposed into a first plurality of decomposed levels in different scales. At step 804, the distorted version of the video frame is decomposed into a second plurality of decomposed levels in different scales.

Step 802 and step 804 may be performed by wavelet transform module 502 in FIG. 5. As shown in FIG. 5, the inputs to process 500 include an original reference image, o, and a test image, t, which is a distorted version of image o. At step (1) of process 500, both images are first processed by a wavelet transform module 502 to generate O and T, where O is the wavelet transform coefficients of image o and T is the wavelet transform coefficients of image t. As shown in FIG. 6, a multi-level Discrete Wavelet Transform (DWT) is applied to the reference image and the test image. The original DLM component metric for VMAF applies a four-level Daubechies 2 (db2) DWT to the video frames 602. Daubechies 2 is a 4-tap wavelet. The decomposition module at each level includes a 4-tap decomposition low-pass filter and a 4-tap decomposition high-pass filter. To reduce the complexity of the computation of DLM, the four-level db2 DWT may be replaced by a four-level Haar DWT. The four-level Haar DWT is simpler to compute with similar or even superior performance, and therefore serves as a basis for both DLM and VIF in the DWT domain.

At step 806 of process 800, detail loss is determined based on the first plurality and second plurality of decomposed levels in different scales. Step 806 may be performed by decoupling module 504, contrast sensitivity function 506, and contrast masking function 508 in process 500, as described above.

The CSF function 506 is implemented as sub-band weighting to account for the contrast sensitivity of the nominal spatial frequency for each level. In some embodiments, the sub-band weights associated with CSF function 506 are those as defined in the original DLM standard. In some embodiments, the sub-band weights are modified based on the new wavelet transform type, i.e., the four-level Haar DWT. For example, the sub-band weights may be adjusted empirically based on the visibility thresholds for wavelet quantization noise.

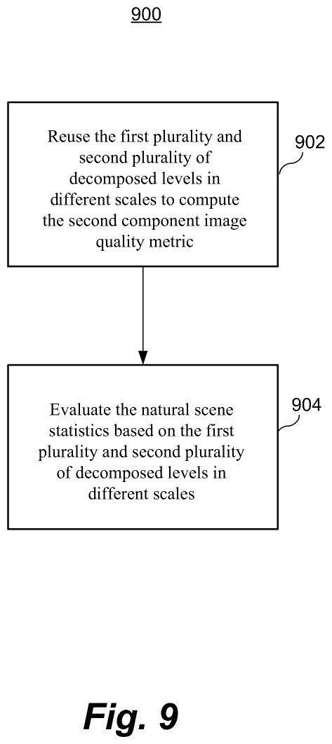

At step 706, a second component image quality metric included in the plurality of eligible component image quality metrics is computed. In some embodiments, the second component image quality metric is VIF, which is one of the three component image quality metrics for VMAF. FIG. 9 illustrates an exemplary process 900 for computing a component image quality metric that evaluates image quality based on natural scene statistics. In some embodiments, process 900 may be performed at step 706 of process 700.

At step 902, the first plurality and second plurality of decomposed levels in different scales are reused for computing the second component image quality metric. FIG. 3 illustrates the original multi-scale pixel domain VIF decomposition 300 that may be applied to the original image and the test image. However, VIF decomposition 300 is computationally intensive; therefore, the decomposed levels in different scales computed for DLM are reused for computing VIF. In particular, the VIF component metric may be computed based on the approximation sub-band at each DWT level, i.e., the LL sub-band of Level-1 wavelet decomposition output 612, the LL sub-band of Level-2 wavelet decomposition output 614. the LL sub-band of Level-3 wavelet decomposition output 616, and the LL sub-band of Level-4 wavelet decomposition output 618, for the original image and the test image.

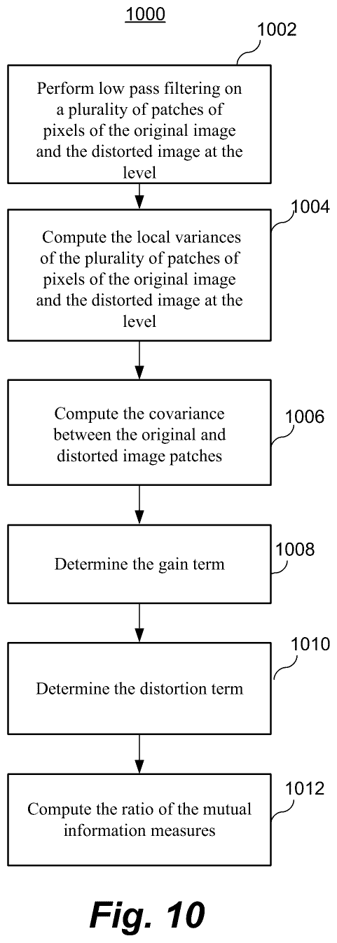

At step 904, natural scene statistics are evaluated based on the first plurality and second plurality of decomposed levels in different scales. VIF uses natural scenes statistics to determine the degree of distortion between the tested video frame and the original video frame. For each scale, the VIF statistics are calculated with a sliding window over the image. FIG. 10 illustrates an exemplary process 1000 for calculating the VIF statistics at each level. In some embodiments, the steps of process 1000 are similar to the steps in process 400; however, some steps in process 1000 may include modifications and additional features to reduce the complexity of the computation of VMAF, as will be described in greater detail below.

At 1002, at each decomposed level, low pass filtering is performed on a plurality of patches of pixels corresponding to the original image. At each decomposed level, low pass filtering is performed on a plurality of patches of pixels corresponding to the distorted image. In some embodiments, instead of using a Gaussian kernel for the low pass filtering, a box window is used for the low pass filtering. The advantage is that a box window only requires summations but not multiplications, thereby reducing the amount of computation needed. Using a box filter may also improve the performance of the video quality metrics. In some embodiments, the box window size is 3×3.

At 1004, the local variances of the plurality of patches of pixels of the original image (σ_{C}²) and the distorted image (σ_{D}²) at the level are computed. At 1006, the covariance between the original and distorted image patches (σ_{CD}) is computed. At 1008, the gain term g is estimated using

$$g = \frac{{σ}_{CD}}{{σ}_{C}^{2}} .$$

At 1010, the distortion term V is determined using σ_{V}²=σ_{D}²−g·σ_{CD}.

At 1012, the ratio of the mutual information measures is computed based on the sum of the local statistics combined as follows:

$$VIF = \frac{{\sum }_{i = 1}^{N} {log}_{2} ( 1 + \frac{{g}_{i}^{2} {σ}_{Ci}^{2}}{{σ}_{{v}_{i}}^{2} + {σ}_{N}^{2}} )}{{\sum }_{i = 1}^{N} {log}_{2} ( 1 + \frac{{σ}_{Ci}^{2}}{{σ}_{N}^{2}} )}$$

where σ_{N}² is a parameter that is a measure of the variance of the HVS system additive noise. In this improved VMAF implementation, σ_{N}² is set at 5 instead of 2 in the original VMAF implementation.

At step 708, a video quality metric for the distorted version with respect to the reference version is determined based on at least a portion of the plurality of eligible component image quality metrics. For example, the video quality metric is determined based on the first component image quality metric determined at step 704 of process 700 and the second component image quality metric determined at step 706 of process 700. In addition, motion is included as the third component image quality metric. Motion may also be beneficially calculated on a LL band of the wavelet pyramid decomposition. As such, it may benefit from the low-pass filtering effect of the wavelet approximation filters, which remove noise elements, and also from the lower pixel count of these LL bands, compared to the original frame pixels. Features from the three component image quality metrics may be fused with a support vector regression (SVR) model to generate the modified VMAF video quality metric. For example, the 4 scale VIF scores, as they are calculated on the 4 LL bands of the wavelet decomposition can serve as features of the support vector regression model, alongside the DLM score evaluated in the same 4 wavelet decomposition scales and motion score features evaluated in the one of the LL bands of the wavelet decomposition.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A method, comprising:
receiving a reference version and a distorted version of a video frame;
calculating a first component image quality metric included in eligible component image quality metrics, comprising:
decomposing the reference version of the video frame into a first set of decomposed levels in different scales;
decomposing the distorted version of the video frame into a second set of decomposed levels in different scales; and
determining detail loss based on the first set of decomposed levels and the second set of decomposed levels in different scales;
calculating a second component image quality metric included in the eligible component image quality metrics, comprising:
reusing the first set of decomposed levels and the second set of decomposed levels in different scales; and
evaluating natural scene statistics based on the first set of decomposed levels and the second set of decomposed levels in different scales; and
based on at least a portion of the eligible component image quality metrics, determining a video quality metric for the distorted version with respect to the reference version.

2. The method of claim 1, wherein the first component image quality metric is Detail Loss Metric (DLM).

3. The method of claim 1, wherein the second component image quality metric is Visual Information Fidelity (VIF).

4. The method of claim 1, wherein decomposing the reference version of the video frame into the first set of decomposed levels in different scales comprises decomposing the reference version of the video frame into a four-level Haar Discrete Wavelet Transform for the reference version, and wherein decomposing the distorted version of the video frame into the second set of decomposed levels in different scales comprises decomposing the distorted version of the video frame into a four-level Haar Discrete Wavelet Transform for the distorted version.

5. The method of claim 1, wherein determining the detail loss based on the first set of decomposed levels and the second set of decomposed levels in different scales comprises applying a Contrast Sensitivity Function (CSF).

6. The method of claim 5, further comprising modifying sub-band weights associated with the CSF based on a type of wavelet transform.

7. The method of claim 6, further comprising modifying the sub-band weights empirically based on visibility thresholds for wavelet quantization noise.

8. The method of claim 1, wherein evaluating the natural scene statistics based on the first set of decomposed levels and the second set of decomposed levels in different scales comprises:
for a decomposed level, performing low pass filtering on patches of pixels corresponding to the reference version of the video frame;
for the decomposed level, performing low pass filtering on patches of pixels corresponding to the distorted version of the video frame; and
wherein a box window is used for the low pass filtering corresponding to the reference version and the distorted version.

9. The method of claim 8, wherein a box window size of the box window is 3×3 in units of pixels.

10. The method of claim 1, wherein calculating the second component image quality metric is based at least in part on a variance of a human visual system (HVS) additive noise, and wherein the variance of the HVS additive noise is set to a value substantially equal to five.

11. A system, comprising:
a memory; and
a processor coupled to the memory and configured to:
receive a reference version and a distorted version of a video frame;
calculate a first component image quality metric included in eligible component image quality metrics, comprising:
decomposing the reference version of the video frame into a first set of decomposed levels in different scales;
decomposing the distorted version of the video frame into a second set of decomposed levels in different scales; and
determining detail loss based on the first set of decomposed levels and the second set of decomposed levels in different scales;
calculate a second component image quality metric included in the eligible component image quality metrics, comprising:
reusing the first set of decomposed levels and the second set of decomposed levels in different scales; and
evaluating natural scene statistics based on the first set of decomposed levels and the second set of decomposed levels in different scales; and
based on at least a portion of the eligible component image quality metrics, determine a video quality metric for the distorted version with respect to the reference version.

12. The system of claim 11, wherein decomposing the reference version of the video frame into the first set of decomposed levels in different scales comprises decomposing the reference version of the video frame into a four-level Haar Discrete Wavelet Transform for the reference version, and wherein decomposing the distorted version of the video frame into the second set of decomposed levels in different scales comprises decomposing the distorted version of the video frame into a four-level Haar Discrete Wavelet Transform for the distorted version.

13. The system of claim 11, wherein determining the detail loss based on the first set of decomposed levels and the second set of decomposed levels in different scales comprises applying a Contrast Sensitivity Function (CSF).

14. The system of claim 13, wherein the processor is configured to modify sub-band weights associated with the CSF based on a type of wavelet transform.

15. The system of claim 14, wherein the processor is configured to modify the sub-band weights empirically based on visibility thresholds for wavelet quantization noise.

16. The system of claim 11, wherein evaluating the natural scene statistics based on the first set of decomposed levels and the second set of decomposed levels in different scales comprises:
for a decomposed level, performing low pass filtering on patches of pixels corresponding to the reference version of the video frame;
for the decomposed level, performing low pass filtering on patches of pixels corresponding to the distorted version of the video frame; and
wherein a box window is used for the low pass filtering corresponding to the reference version and the distorted version.

17. The system of claim 16, wherein a box window size of the box window is 3×3 in units of wavelet coefficients.

18. The system of claim 11, wherein calculating the second component image quality metric is based at least in part on a variance of a human visual system (HVS) additive noise, and wherein the variance of the HVS additive noise is set to a value substantially equal to five.

19. A computer program product embodied in a non-transitory computer readable medium and comprising computer instructions for:
receiving a reference version and a distorted version of a video frame;
calculating a first component image quality metric included in eligible component image quality metrics, comprising:
decomposing the reference version of the video frame into a first set of decomposed levels in different scales;
decomposing the distorted version of the video frame into a second set of decomposed levels in different scales; and
determining detail loss based on the first set of decomposed levels and the second set of decomposed levels in different scales;
calculating a second component image quality metric included in the eligible component image quality metrics, comprising:
reusing the first set of decomposed levels and the second set of decomposed levels in different scales; and
evaluating natural scene statistics based on the first set of decomposed levels and the second set of decomposed levels in different scales; and
based on at least a portion of the eligible component image quality metrics, determining a video quality metric for the distorted version with respect to the reference version.

20. The computer program product of claim 19, wherein decomposing the reference version of the video frame into the first set of decomposed levels in different scales comprises decomposing the reference version of the video frame into a four-level Haar Discrete Wavelet Transform for the reference version, and wherein decomposing the distorted version of the video frame into the second set of decomposed levels in different scales comprises decomposing the distorted version of the video frame into a four-level Haar Discrete Wavelet Transform for the distorted version.
